(19) United States
(12) Patent Application Publication
(10) Pub. No.: US 2026/0350239 A1
(43) Pub. Date: Nov. 5, 2026

(54) SYSTEMS AND METHODS FOR DETECTING DATA TRANSFER ATTEMPTS VIA IMAGE CAPTURE

(71) Applicant: Teachers Insurance and Annuity Association of America, New York, NY (US)

(72) Inventors: Sheikh Javed Alam, Bangalore (IN); Upendra Mardikar, Fremont, CA (US); Deepak Gupta, Pune (IN); A M Aysha Nahan, Kochi (IN)

(21) Appl. No.: 19/198,889

(22) Filed: May 5, 2025

(51) Int. Cl. G06F 21/84; G06F 21/55; H04W 12/65

(52) U.S. Cl. CPC G06F 21/84; G06F 21/554; H04W 12/65

(57) ABSTRACT

A method of protecting a data exfiltration attempt of a computing device by a user. The method may comprise detecting a presence of sensitive data displayed on a computing device, detecting a data exfiltration attempt associated with the sensitive data by a user via the computing device, disabling one or more functionalities associated with the computing device, and blocking network traffic activities between the computing device and another device.

### FIELD OF THE DISCLOSURE

The present disclosure relates to systems and methods for detecting and preventing unauthorized data transfer attempts by monitoring user activity, analyzing visual streams for secondary camera usage, and applying automated security measures to mitigate potential data exfiltration.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

As technology becomes more mobile and difficult to directly monitor, new challenges arise in protecting sensitive corporate data from unauthorized access and transfer. For example, employees working and/or otherwise operating outside the controlled security perimeters of an organization's network may lead to an increase in the risk of data leaks and insider threats. One such challenge is detecting unauthorized data transfer attempts (e.g., data exfiltration attempts) that utilize image capture technology and/or external devices rather than traditional digital transmission methods from the monitored and/or secure device. For example, a user may attempt to bypass security restrictions by capturing images of sensitive information displayed on their screen using an external device, such as a smartphone, tablet, or secondary camera. Unlike conventional data transfer mechanisms, such as email, USB storage, or cloud uploads, these image-based exfiltration attempts occur outside the organization's direct control, making them difficult to detect and prevent.

Current security solutions lack effective mechanisms to identify and respond to such unauthorized activities in real time. While screen capture detection and network activity monitoring can provide some level of protection, such techniques are ineffective against visual data exfiltration through external recording devices. As a result, there is a growing need for improved systems and methods to detect and prevent unauthorized data transfer attempts, particularly those involving external recording devices, without disrupting normal business operations.

### SUMMARY

In some aspects, the techniques described herein relate to a method of protecting a data exfiltration attempt of a computing device by a user, the method including: detecting, by one or more processors, a presence of sensitive data displayed on a computing device by applying a sensitive data detection module to screen data; detecting, by the one or more processors, a data exfiltration attempt associated with the sensitive data by a user via the computing device; disabling, by the one or more processors and responsive to the detecting of the data exfiltration attempt, one or more functionalities associated with the computing device; and blocking, by the one or more processors, network traffic activities between the computing device and another device.

In some aspects, the techniques described herein relate to a method, wherein the detecting of the data exfiltration attempt further includes: detecting, by the one or more processors, at least one of a camera lens of a user device or an attempt to disrupt one or more cameras of the computing device.

In some aspects, the techniques described herein relate to a method, wherein the detecting of the at least one of the camera lens or the attempt to disrupt further includes: receiving, by the one or more processors from the one or more cameras of the computing device, a visual stream of visual data; and performing at least one of: detecting, by the one or more processors, the camera lens by using an object recognition module to the visual stream; or analyzing, by the one or more processors, the visual stream to detect the attempt to disrupt the one or more cameras.

In some aspects, the techniques described herein relate to a method, wherein the detecting of the data exfiltration attempt further includes: detecting, by the one or more processors, a screen capture event of the computing device.

In some aspects, the techniques described herein relate to a method, further including: determining, by the one or more processors, at least one of a threat score of the user or anomalies in past user activity data that indicate possible data exfiltration attempts by using a user activity module.

In some aspects, the techniques described herein relate to a method, wherein the past user activity data includes at least one of: user web activity, user endpoint activity, user email activity, user cloud activity, or user sign-in activities.

In some aspects, the techniques described herein relate to a method, wherein the blocking of the network traffic activities between the computing device and the another device further includes at least one of: sending, by the one or more processors, an automated email to administrators; disabling, by the one or more processors newly added network shared drives, blocking, by the one or more processors, outbound emails, disabling, by the one or more processors, web based data transfers, disabling, by the one or more processors, any USB data transfer activities, or enabling, by the one or more processors, automated text scanning.

In some aspects, the techniques described herein relate to a method, further including: generating, by the one or more processors, an activity report of the user by using a report generation module on past user activity data or the blocked network traffic activities.

In some aspects, the techniques described herein relate to a method, wherein the disabling of the one or more functionalities associated with the computing device further includes at least one of: locking, by the one or more processors, a user screen of the computing device requiring a passcode, deleting, by the one or more processors, existing content of the computing device, freezing, by the one or more processors, the user screen of the computing device, darkening, by the one or more processors, the user screen of the computing device, or disabling, by the one or more processors, a keyboard and a mouse of the computing device.

In some aspects, the techniques described herein relate to a method, further including: transmitting, by the one or more processors, a passcode to a user device of the user that, when input into the user device, enables the one or more functionalities; receiving, by the one or more processors from the computing device, the passcode; and enabling, by the one or more processors, the one or more functionalities.

In some aspects, the techniques described herein relate to a computer system for protecting a data exfiltration attempt of a computing device by a user, including: one or more processors, and a tangible, non-transitory memory coupled to the one or more processors and storing executable instructions that, when executed by the one or more processors, causes the computer system to: detect a presence of sensitive data displayed on a computing device by applying a sensitive data detection module to screen data; detect a data exfiltration attempt associated with the sensitive data by a user via the computing device; disable, responsive to the detecting of the data exfiltration attempt, one or more functionalities associated with the computing device; and block network traffic activities between the computing device and another device.

In some aspects, the techniques described herein relate to a computer system, wherein the instructions to detect the data exfiltration attempt include further instructions that, when executed by the one or more processors, further causes the computer system to: detect at least one of a camera lens of a user device or an attempt to disrupt one or more cameras of the computing device.

In some aspects, the techniques described herein relate to a computer system, wherein the instructions to detect at least one of the camera lens or the attempt to disrupt include further instructions that, when executed by the one or more processors, further causes the computer system to: receive, from the one or more cameras of the computing device, a visual stream of visual data; and perform at least one of: detect the camera lens by using an object recognition module to the visual stream; or analyze the visual stream to detect an attempt to disrupt the one or more cameras.

In some aspects, the techniques described herein relate to a computer system, wherein the instructions to detect the data exfiltration attempt include further instructions that, when executed by the one or more processors, further causes the computer system to: detect a screen capture event of the computing device.

In some aspects, the techniques described herein relate to a computer system, wherein the instructions, when executed by the one or more processors, further causes the computer system to: determine at least one of a threat score of the user or anomalies in past user data that indicate possible data exfiltration attempt by using a user activity module.

In some aspects, the techniques described herein relate to a computer system, wherein the past user activity data includes at least one of: user web activity, user endpoint activity, user email activity, user cloud activity, or user sign-in activities.

In some aspects, the techniques described herein relate to a computer system, wherein the instructions to block network traffic activities between the computing device and another device include further instructions that, when executed by the one or more processors, further causes the computer system to perform at least one of: send an automated email to administrators; disable newly added network shared drives, block outbound emails, disable web based data transfers, disable any USB data transfer activities, or enable automated text scanning.

In some aspects, the techniques described herein relate to a non-transitory computer-readable medium storing executable instructions for protecting a data exfiltration attempt of a computing device by a user that, when executed by one or more processors, causes a computing system to: detect a presence of sensitive data displayed on a computing device by applying a sensitive data detection module to screen data; detect a data exfiltration attempt associated with the sensitive data by a user via the computing device; disable, responsive to the detecting of the data exfiltration attempt, one or more functionalities associated with the computing device; and block network traffic activities between the computing device and another device.

In some aspects, the techniques described herein relate to a non-transitory computer-readable medium, wherein the instructions further cause the computing system to: generate an activity report of the user by using a report generation module on past user activity data or the blocked network traffic activities.

In some aspects, the techniques described herein relate to a non-transitory computer-readable medium, wherein the instructions to disable the one or more functionalities associated with the computing device further cause the computing system to: lock a user screen of the computing device requiring a passcode, delete existing content of the computing device, freeze the user screen of the computing device, darken the user screen of the computing device, or disable a keyboard and a mouse of the computing device.

### BRIEF DESCRIPTION OF THE DRAWINGS

FIG. 1 is a block diagram of an example communication system in which a method for protecting a data transfer attempt, such as a data exfiltration attempt, can be implemented.

FIG. 2 is a block diagram of an example security server that can operate in the system of FIG. 1.

FIG. 3 is an example flow diagram for protecting a data transfer attempt by a security server according to some embodiments.

FIG. 4A is an example illustration of a user using a user device to perform a data transfer attempt of a working device.

FIG. 4B is an example illustration of a disabling the user screen of the working device by darkening in reaction to the data transfer attempt.

FIG. 5 is a flow diagram of an example method for protecting a data transfer attempt of a working device (e.g. computing device) by a user, according to some embodiments.

FIG. 6 depicts an example block flow diagram for developing a finetuned language model, according to some aspects.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Broadly speaking, the techniques of the present disclosure relate to detecting and preventing unauthorized data transfer attempts (e.g., data exfiltration attempts) by detecting a presence of sensitive data on a screen of a computing device, detecting a data transfer attempt associated with the sensitive data by a user via the computing device, and applying automated security measures (e.g., disabling one or more functionalities associated with the computing device, blocking network traffic activities between the computing device and another device, etc.). The detecting of the data transfer attempt of the computing device by a user may include detecting a camera lens of a user device or an attempt to disrupt one or more cameras of the computing device, detecting a screen capture event, etc. The one or more functionalities that are disabled may include locking a user screen of the computing device, deleting an existing content of the computing device, etc.

Existing security mechanisms, such as data loss prevention (DLP) systems, endpoint monitoring, and access control policies, are primarily designed to track network-based exfiltration attempts. However, conventional techniques fail to effectively detect data leaks occurring through indirect data transfer attempts, such as when a user records sensitive information displayed on a screen using an external device, or detecting screen-grabbing attempts (e.g., screen recording) using internal software. The challenge of indirect data transfer attempts is even more relevant in remote work settings, where the user can easily utilize a user device to capture information displayed in the computing device without interruption. Accordingly, the present techniques aim to improve the data security by protecting a data transfer attempt of a computing device by a user by, for example, (i) detecting a data transfer attempt by detecting the presence of sensitive data; (ii) detecting a data transfer attempt by a user via the computing device (e.g., the user using a camera to capture sensitive data); upon detection, (iii) disabling one or more functionalities associated with the computing device; and (iv) blocking network traffic activities between the computing device and another device. The present disclosure addresses these shortcomings by providing a novel system that integrates real-time visual detection (e.g., one or more cameras) with behavioral analysis (e.g., to detect the presence of sensitive data) to mitigate such threats.

Conventional security solutions are ineffective at detecting external recording devices, such as smartphones, tablets, or secondary cameras, which can be used to exfiltrate sensitive information without triggering traditional monitoring systems. Existing methods often rely on heuristic-based monitoring, which is prone to false positives and fails to identify covert data transfer attempts. For example, these systems may detect anomalous network activity but remain blind to physical data exfiltration through external cameras. In contrast, the present disclosure overcomes such limitations by introducing a trained neural network that detects camera lenses and identifies attempts to obstruct built-in security cameras of a computing device. By applying an object recognition module to real-time visual streams, the system accurately identifies potential threats without depending solely on network-based security measures. This approach provides an additional layer of detection for unauthorized data transfer attempts, significantly improving detection accuracy and enhancing an organization's ability to prevent data exfiltration.

Additionally, conventional systems typically lack a comprehensive approach to analyzing user behavior over time to assess the likelihood of an unauthorized data transfer attempt. For example, existing approaches may flag isolated incidents, such as an unusual login attempt or a large file transfer, but lack the contextual understanding needed to recognize evolving threat patterns. As a result, these systems struggle to distinguish between routine user activities and genuine security risks. By contrast, the present disclosure introduces an AI-powered risk scoring system that evaluates past user activity across multiple domains, including endpoint interactions, web activity, email exchanges, cloud access, and sign-in patterns. The present disclosure dynamically adjusts risk scores based on anomalous behaviors, allowing organizations to proactively identify users exhibiting high-risk patterns.

Another technical limitation of existing security mechanisms is the lack of real-time, automated responses to detected data transfer attempts. Traditional DLP solutions rely on predefined rules and manual intervention, resulting in delayed enforcement and potential security breaches. These systems may detect suspicious activity but require administrative action to implement protective measures, creating gaps in security enforcement. In contrast, the present disclosure overcomes these limitations by implementing an automated response system that disables one or more functionalities (e.g., locking user screen, deleting existing content, freezing the user screen, disabling a keyboard and a mouse, etc.) associated with the computing device upon detection of an unauthorized data transfer attempt. The techniques described herein can also enable blocking of network traffic activities (e.g., block outbound communications, prevent access to shared drives, restrict web-based data transfers, etc.), thereby preventing sensitive data from leaving the controlled environment. Furthermore, the system may generate an audit trail and escalate incidents to security teams, ensuring comprehensive monitoring and accountability.

Therefore, and in accordance with the above, the techniques of the present disclosure improve the functionality of a computing device (e.g., a hosting server such as a central server) at least by providing real-time detection of unauthorized data transfer attempts, integrating AI-driven risk analysis, and enabling automated security responses. By combining object recognition for camera detection, behavioral anomaly detection, and proactive security enforcement, the present disclosure significantly enhances data protection capabilities beyond conventional security mechanisms. This system of the present techniques (and by extension, the underlying computing device) can thus more securely prevent a data transfer attempt of a computing device by a user by effectively preventing data leaks occurring through external recording devices, thereby addressing a critical gap in existing security technologies.

Still further, the present disclosure includes specific features other than what is well-understood, routine, conventional activity in the field, or adding unconventional steps that demonstrate, in various embodiments, particular useful applications, e.g., detecting a presence of sensitive data displayed on a computing device by applying a sensitive data detection module to screen data; detecting a data transfer attempt associated with the sensitive data by a user via the computing device; disabling one or more functionalities associated with the computing device; and/or blocking the user from performing any data transfer activities on the computing device.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the medical context, the techniques described herein may be readily applied in any suitable field for any suitable purpose.

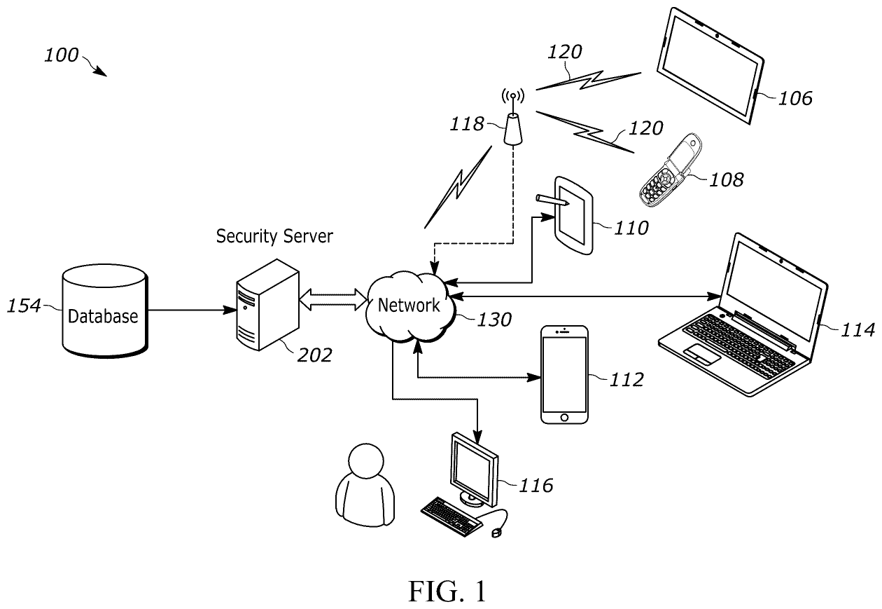

Referring to FIG. 1, an example comprehensive security system 100 includes a security server 202 and working devices (i.e., computing devices) 106-116 which may be communicatively connected through a network 130, as described below. The working devices 106-116 may be devices of an organization utilized by a user to perform a task for the organization, and may have access to sensitive organization information. Each of the working devices 106-116 may interact with the security server 202 to transmit information regarding a data transfer attempt (e.g., a data exfiltration attempt), and in response, may receive instructions to disable one or more functionalities and/or block the user from performing further data transfer activities.

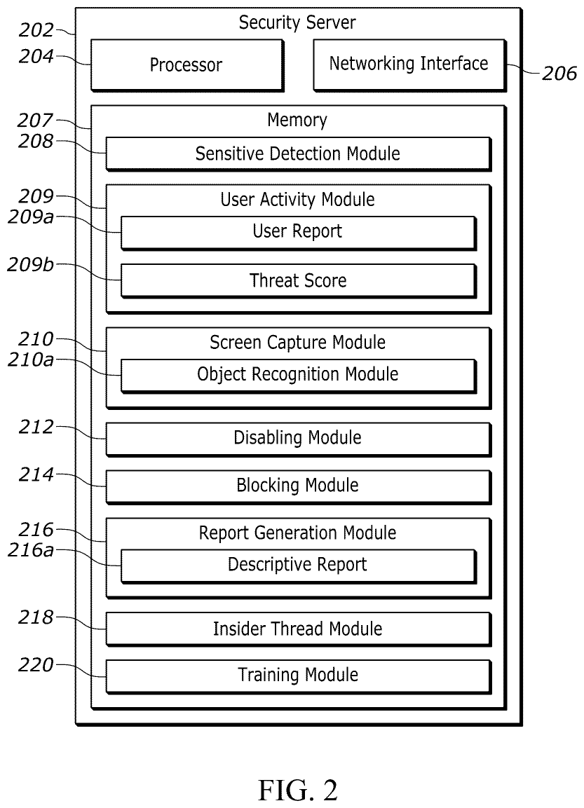

The security server 202 may monitor the working devices 106-116 and analyze incoming data to detect potential security threats. The security server 202 may analyze whether the displayed data in the working devices 106-116 is sensitive (e.g., by applying a sensitive data detection module 208 described in FIG. 2). Upon detecting that the displayed data is sensitive, the security server 202 may then detect whether there is a data exfiltration attempt of the sensitive data (e.g., by applying screen capture module 210 in FIG. 2). For example, the security server 202 may detect the data exfiltration attempt by analyzing visual stream(s) of visual data (e.g., images and/or videos) from one or more cameras of the working devices 106-116, detecting a screen capture event of the user, etc. When the security server 202 detects both (i) the presence of sensitive data on display and (ii) an active data exfiltration attempt, the security server 202 may transmit instructions to the working devices 106-116 to disable one or more functionalities (e.g., locking user screen, deleting existing content, freezing the user screen, disabling a keyboard and a mouse) and/or block network traffic activities (e.g., send an automated email to administrators, disable newly added network shared drives, block outbound emails, disable web based data transfers, disable any USB data transfer activities, enable automated text scanning, etc.) for the corresponding working device of the working devices 106-116, thereby preventing unauthorized data exfiltration.

In some embodiments, the working devices 106-116 may independently perform analysis on the data to determine potential security threats. For example, the working devices 106-116 may analyze whether the displayed data is sensitive and, upon detection, notify the security server 202 that the currently displayed data contains sensitive information. Additionally, the working devices 106-116 may detect a data exfiltration attempt by a user. Similar to the security server 202, the working devices 106-116 may assess various user activities, such as screen captures or external camera usage, to determine whether a data exfiltration attempt is occurring. Upon making such a determination, the working devices 106-116 may send a notification to the security server 202 regarding the detected data exfiltration attempt.

Upon receiving notifications of both (i) the presence of sensitive data and (ii) a data exfiltration attempt, the security server 202 may instruct the working devices 106-116 to disable one or more functionalities and block network traffic activities. In some embodiments, rather than acting immediately on the notifications, the security server 202 may further analyze the received data to validate the reported findings. If the security server 202 confirms the presence of sensitive data and a data exfiltration attempt, it may then transmit instructions to the working devices 106-116 to disable their functionalities and enforce network restrictions. This additional validation step ensures accuracy in enforcement and reduces the likelihood of false positives.

The security server 202, when analyzing information before determining whether to disable and block the working devices 106-116, may access a database 154 to retrieve additional information about the user. The database 154 may store various user activity records within the organization, including web activity, endpoint activity, email activity, cloud activity, sign-in history, and office activities. By leveraging this historical data, the security server 202 can perform a behavioral analysis to assess patterns and anomalies associated with the user's activity. The security server 202 may then apply a machine learning model to analyze the retrieved user information and generate a user threat score (e.g., via user activity module 209 of FIG. 2), indicating the likelihood that the user is attempting unauthorized data exfiltration. If the threat score exceeds a predefined threshold, the security server 202 may determine that an immediate security action, such as disabling device functionalities and blocking network activities, is necessary.

The database 154 may also store various visual streams (e.g., images and videos) that the security server 202 utilizes to train a machine learning model for detecting camera lenses, smart phones, and/or other indications of an imaging device (e.g., object recognition module 210a of FIG. 2). This model enables the security server 202 to identify potential data exfiltration attempts involving external recording devices. Additionally, the database 154 may contain screen image datasets used to train another machine learning model that determines whether a user's screen is displaying sensitive data (e.g., sensitive data detection module 208 of FIG. 2). This model allows the security server 202 to accurately detect and classify sensitive content in real time. Furthermore, the database 154 may store historical user activity data, which may be used to train a risk assessment model (e.g., machine learning model) for generating a user threat score, indicating the likelihood of a user engaging in unauthorized data exfiltration attempts.

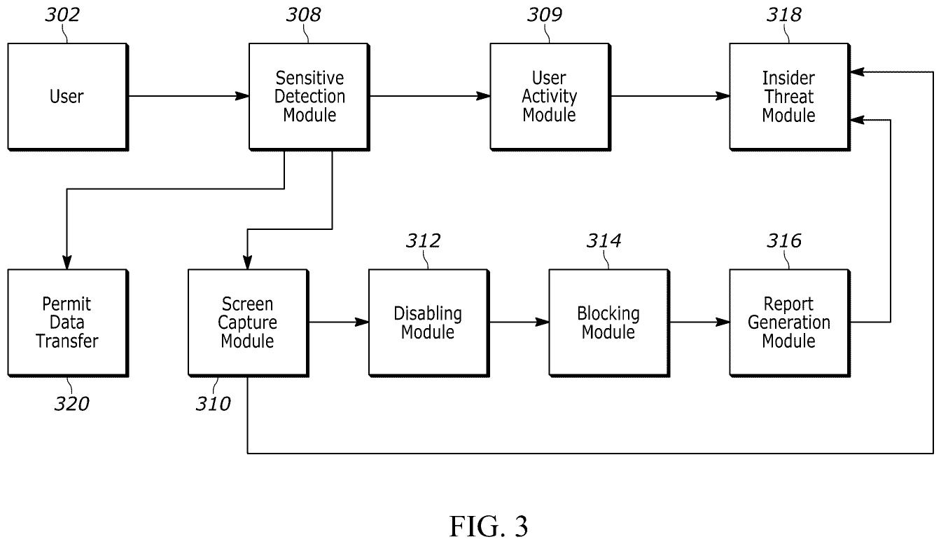

Each of the working devices 106-116 may communicate with the security server 202 to transmit information and/or notifications regarding detected data exfiltration attempts. For example, a working device may send a notification to the security server 202 responsive to detecting that a user device (e.g., a smartphone or tablet, as described below with regard to FIG. 3) is being used to capture photos of sensitive information displayed on its screen. In another example, the working device may transmit notifications when the user obstructs one or more built-in cameras for the working device, potentially attempting to bypass security monitoring. Additionally, a notification may be sent when sensitive information is displayed on the working device, triggering further security analysis. These real-time notifications allow the security server 202 to promptly assess and respond to potential data exfiltration threats.

The security server 202 may use one or more machine learning models such that each model/engine “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one machine learning method and algorithm may be applied, which may include but is not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of several categorizations of machine learning, such as supervised learning, unsupervised learning, and reinforcement learning.

In some embodiments, the one or more machine learning models used to detect and/or protect against a data exfiltration attempt (e.g., sensitive data detection module 208, user activity module 209, screen capture module 210, etc. as described below with regard to FIG. 2) may employ supervised learning, which involves identifying patterns in existing data to make predictions about subsequently received data. Specifically, the one or more machine learning models may be “trained” using training data, which includes example inputs and associated example outputs. Based upon the training data, the one or more machine learning models may generate a predictive function which maps outputs to inputs and may utilize the predictive function to generate machine learning outputs based upon data inputs.

In further embodiments, the one or more machine learning models used to detect and/or protect against a data exfiltration attempt may employ unsupervised learning, which involves finding meaningful relationships in unorganized data. Unlike supervised learning, unsupervised learning does not involve user-initiated training based upon example inputs with associated outputs. Rather, in unsupervised learning, the one or more machine learning models used to protect a data exfiltration attempt may organize unlabeled data according to a relationship determined by at least one machine learning method/algorithm employed by the one or more machine learning models used to protect a data exfiltration attempt. Unorganized data may include any combination of data inputs and/or machine learning outputs as described above.

In yet further embodiments, the one or more machine learning models used to detect and/or protect against a data exfiltration attempt may employ reinforcement learning, which involves optimizing outputs based upon feedback from a reward signal. Specifically, the one or more machine learning models used to protect a data exfiltration attempt may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

After training, machine learning programs (or information generated by such machine learning programs) may be used to evaluate additional data. Such data may be and/or may be related to intent data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset.

It is to be understood that supervised machine learning and/or unsupervised machine learning may also comprise retraining, relearning, or otherwise updating models with new, or different, information, which may include information received, ingested, generated, or otherwise used over time.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In some embodiments, the security server 202 may communicate via wireless signals 120 over a digital network 130 with the working devices 106-116, which can be any suitable local or wide area network(s) including a Wi-Fi network, a Bluetooth network, a cellular network such as 3G, 4G, Long-Term Evolution (LTE), 5G, the internet, etc. In some instances, the working devices 106-116 may communicate with the digital network 130 via an intervening wireless or wired device 118, which may be a wireless router, a wireless repeater, a base transceiver station of a mobile telephony provider, etc.

The working devices 106-116 may include, by way of example, a tablet computer 106, a network-enabled cell phone 108, a personal digital assistant (PDA) 110, a mobile device smart-phone 112 also referred to herein as a “mobile device,” a laptop computer 114, a desktop computer 116, a portable media player (not shown), a wearable computing device such as Google Glass™ (not shown), a smart watch, a phablet, any device configured for wired or wireless RF (Radio Frequency) communication, etc.

Turning now to FIG. 2, the security server 202 may include one or more processors 204, a networking interface 206, and one or more memories 207. The memories 207 may comprise a sensitive data detection module 208, activity module 209, a screen capture module 210, a disabling module 212, a blocking module 214, a report generation module 216, and an insider threat module 218. The user activity module 209 may comprise a user report 209a and threat score 209b. The screen capture module 210 may comprise an object recognition module 210a. The report generation module 216 may comprise a past user activity report 216a and a descriptive report 216b. The security server 202 may be connected to a database 154, which stores (i) training data that the security server 202 can use to train the one or more machine learning models and/or (ii) user data that the security server 202 can use to analyze the user.

The security server 202 may utilize the sensitive data detection module 208 to determine whether sensitive information is displayed on the screens of the working devices 106-116. Sensitive information may include, but is not limited to, social security numbers, home addresses, financial records, proprietary organizational documents, intellectual property, and classified technological reports. The sensitive data detection module 208 may employ a confidential machine learning model trained to detect sensitive content in real time. The confidential machine learning model may be trained using labeled datasets (stored in the database 154) comprising classified sensitive information, allowing it to accurately distinguish between general and sensitive data displayed on the working devices 106-116. Once trained, the sensitive data detection module 208 can analyze screen content and determine whether the screen content contains sensitive data, triggering appropriate security actions if necessary and/or as indicated. For example, if a user opens a financial report containing confidential revenue projections or an internal document marked as classified in the working device, the sensitive data detection module 208 may analyze the displayed content in real time and determine that the sensitive data is displayed in the working device.

In some embodiments, the sensitive data detection module 208 may utilize an entity recognition model configured with pre-defined rules for detecting sensitive information. For instance, the entity recognition model may be pre-configured to flag certain keywords or phrases, such as “social security number,” “confidential,” or “classified,” ensuring immediate classification of displayed content as sensitive. Such an approach allows for rule-based detection that complements machine learning-based classification, improving detection accuracy and adaptability across different types of sensitive data.

The user activity module 209 may analyze user data (i.e., past user activity data) stored in the database 154 to generate a user report 209a (i.e., activity report) and a threat score 209b. The user data may include various activity records, such as web activity, endpoint activity, email exchanges, cloud interactions, sign-in logs, and work-related actions. The user report 209a may provide analytics that identify anomalous user behaviors by comparing the user's activity to historical patterns, predefined risk indicators, and organizational policies. For example, the user report 209a may highlight deviations such as an unusual frequency of file transfers, multiple failed sign-in attempts, or unexpected access to restricted documents. Such insights may provide information on whether a user's actions align with normal work activities or indicate a potential insider threat. The user report 209a may also comprise descriptive report, or summarization, of past user activities. The threat score 209b quantifies the level of risk a user poses to the organization based on, but not limited to, user behavior, role, and/or access privileges. For instance, a high-ranking employee with broad access to confidential data who exhibits anomalous behaviors, such as attempting to copy classified documents outside normal work hours, may receive a high threat score due to the potential impact of unauthorized actions. Conversely, a lower-ranking employee with limited access to sensitive data and infrequent anomalous activities may receive a lower threat score, as the user behavior presents a comparatively reduced risk.

The user activity module 209 may utilize a user activity machine learning model to identify anomalous user behavior. This model may be trained using labeled datasets containing examples of both normal and anomalous behaviors, enabling it to recognize deviations from expected activity patterns. The training data may include historical user activity logs, flagged security incidents, and/or predefined risk indicators to improve detection accuracy. For example, the user activity module 209 may identify a sudden increase in file access requests, multiple failed login attempts across different locations, and/or attempts to bypass security controls as signs of potential unauthorized activity. The user activity machine learning model may then generate the user report 209a, detailing different anomalous behaviors that the user activity machine learning model found and/or summarization of user's past activity record.

In some embodiments, the user activity module 209 may incorporate contextual analysis to determine whether an identified behavior is genuinely suspicious or part of a legitimate work pattern. For instance, if a user downloads a large dataset, the system may assess whether the user is authorized to access such files, whether the action is consistent with historical work patterns for the user, and/or whether the activity occurs within expected business hours. If the behavior aligns with the user's normal duties, the system may classify the behavior as low-risk. However, if the action is unusual or inconsistent with past activities, the user activity module 209 may flag the action for further review or escalate security measures.

The user activity machine learning model may also be used to determine the threat score 209b, providing a quantitative assessment of security risk for a user based on behavior, access level, and historical activity patterns for the user. The user activity module 209 may train the model using labeled datasets that associate specific behaviors with varying levels of risk, allowing it to generate a dynamic, real-time assessment of user threats. For example, if a high-privilege user suddenly accesses restricted files from an unrecognized location, the model may assign a high threat score, indicating a potential security risk. Conversely, if a low-privilege user performs similar actions within the usual work environment for the user, the model may assign a lower threat score, reflecting a lower level of risk.

Similar to the user report 209a, the user activity module 209 may incorporate contextual analysis to dynamically assess the threat score based on multiple factors. For instance, if a user with high access privileges downloads a significant number of files but has prior authorization, the system may adjust the threat score downward to reflect legitimate access. On the other hand, if the same user attempts to transfer those files to an external location, the system may increase the threat score, triggering immediate security actions such as access restrictions, administrative notifications, or device lockdowns.

In some embodiments, the user activity module 209 may utilize separate machine learning models for generating the user report 209a and the threat score 209b. For instance, the user activity module 209 may train a user report machine learning model specifically designed to analyze user behavior patterns and generate descriptive reports on anomalous activities. Simultaneously, a separate threat score machine learning model may be trained to assess the severity of detected behaviors and calculate a corresponding threat score 209b.

The screen capture module 210 may detect a data transfer attempt (e.g., a data exfiltration attempt) by a user via the working devices 106-116. For example, the screen capture module 210 may detect such an attempt by detecting the presence of one or more camera lenses of a user device (e.g., a smartphone, tablet, or external camera), an attempt to disrupt one or more cameras of the working devices 106-116 (e.g., covering or disabling them), and/or a screen capture event initiated on the working device (e.g., screen recording or screen capture).

The screen capture module 210 may detect the camera lens of a user device by receiving a visual stream of visual data captured by one or more cameras of the working device. The visual data may include images or video recordings that reflect real-time actions of the user. The screen capture module 210 may then initiate and/or utilize an object recognition module to analyze the visual stream and detect the presence of one or more camera lenses within the scene. The object recognition module 210A may utilize an object recognition machine learning model trained to detect camera lenses from various angles, lighting conditions, and device types. The screen capture module 210 may train the object recognition model using a dataset comprising images and recordings of various camera lenses, ensuring accurate detection across different environments and user behaviors. For example, the object recognition model may be trained to recognize camera lenses from smartphones, tablets, webcams, or external recording devices, even when partially obscured or positioned at non-standard angles.

The object recognition machine learning model and/or another trained machine learning model may also detect an attempt to disrupt or obstruct the working device's cameras. Such disruptions may include a user covering the camera with an object, applying software-based interference to disable or blur the camera feed, or adjusting the camera's angle to avoid detection. To enhance its accuracy, the screen capture module 210 may train the object recognition model using a dataset comprising images and recordings of various obstruction techniques. For example, the dataset may include instances of users placing stickers or tape over the camera, blocking the lens with their hand, or using external covers to prevent visibility. Additionally, the model may be trained to recognize digital obfuscation methods, such as screen overlays or software-based tampering that interrupts the camera feed. The object recognition machine learning model may also detect any instances of the camera being intentionally turned off and/or disabled.

In some embodiments, the object recognition module 210A may employ synthetic image generation techniques to create additional training data. This approach is particularly useful in scenarios where real-world samples are limited or difficult to capture. Synthetic images may be generated using computer-generated imagery (CGI), generative adversarial networks (GANs), and/or procedural rendering techniques to simulate different camera lenses and obstruction scenarios. For example, the system may generate 3D renderings of various camera types under different lighting conditions, occlusions, and angles to improve model robustness. Furthermore, synthetic images can be used to simulate edge cases, such as reflections of cameras in glossy surfaces, blurred or distorted images due to movement, and partial occlusions that may occur in real-world settings. By augmenting real-world datasets with synthetic images, the object recognition module 210A ensures that the model remains adaptable and capable of accurately detecting unauthorized recording attempts across a wide range of conditions.

In addition to detecting physical attempts to capture sensitive information, the screen capture module 210 may also identify software-based data exfiltration attempts. These attempts may include taking a screenshot, initiating a screen recording, enabling screen sharing via collaboration software, or broadcasting the display using remote access tools. The screen capture module 210 may monitor the working device's operating system and applications for signs of such activities, such as invoking a screenshot function, launching screen recording software, or activating screen-sharing protocols.

In some embodiments, the screen capture module 210 may incorporate a timer-based detection mechanism to identify data capture attempts. When sensitive information is detected on the working device's screen, a countdown timer may be initiated. If the screen capture module 210 detects that the sensitive content remains on display beyond a predefined duration (e.g., without user action), the screen capture module 210 may identify the display of sensitive information to be associated with an attempt to perform the data exfiltration attempt.

The disabling module 212, upon detecting the data exfiltration attempt associated with the sensitive data and/or the screen capture module 210 detecting an attempt to capture data, may disable one or more functionalities associated with the working devices 106-116 to prevent unauthorized data exfiltration. The disabling process may include, but is not limited to, locking the user screen, deleting existing content, darkening the screen, freezing the user interface, and/or disabling input peripherals such as the keyboard and mouse. For example, if a user attempts to take a screen capture of sensitive information, the disabling module 212 may immediately darken the screen and disable further screen capture capabilities, preventing the user from saving or sharing the captured content. If the security server detects that a user is trying to copy sensitive data to an external USB device, the disabling module 212 may disable USB ports, ensuring that no data can be transferred. Such actions help prevent the user from continuing the data exfiltration attempt associated with the sensitive data and restrict the ability of the user to circumvent security measures. In some embodiments, the disabling module 212 may also disable other working devices associated with the user when a data exfiltration attempt is detected. For example, if the user is performing a data exfiltration attempt on working device 106 while also having active sessions on working devices 108 and 110, the disabling module 212 may extend the security response to immediately disable those additional devices. This feature ensures that users cannot bypass security controls by switching to another authorized device within the organization's network.

The blocking module 214 may restrict network traffic activities between the working devices 106-116 and another device to prevent unauthorized data exfiltration. The “another device” may refer to an external server, a cloud storage service, an email recipient, a removable storage device, or any other system that could facilitate data transfer outside the organization's controlled environment. By intercepting and regulating data flow, the blocking module 214 ensures that sensitive information remains protected.

For example, if a user attempts to upload confidential files to an unauthorized cloud storage service, such as a personal Google Drive or Dropbox account, the blocking module 214 may immediately terminate the network connection to the service, preventing the upload from completing. Similarly, if the system detects that a user is attempting to send an email containing sensitive information to an external recipient, it may block the email from being sent and issue an alert to administrators. If a USB device is connected and an attempt is made to transfer data, the module may disable data write permissions on the USB port, ensuring that no files can be copied.

In some embodiments, the additional device may also include internal servers within the organization that are typically accessible from the working devices 106-116 under normal conditions, such as through an intranet, a virtual private network (VPN), or remote desktop connections. In some cases, the user may attempt to transfer sensitive data to an internal but unauthorized location with the intention of later retrieving it from a different endpoint. To mitigate such risks, the blocking module 214 may disconnect or block network access between the working devices 106-116 and internal servers, effectively preventing the user from accessing, transferring, or retrieving files stored within the internal network. By severing the connection to internal repositories, the blocking module 214 ensures that even if a user has existing access privileges, the user cannot exploit internal pathways to bypass security controls and facilitate unauthorized data movement.

For instance, if a user is detected engaging in a suspicious data exfiltration attempt, the blocking module 214 may immediately sever the user's connection to all internal servers, preventing access to organization-wide databases, intranet portals, and internal file storage systems. If the user attempts to open a document stored on a company server or access a shared internal repository via a mapped network drive, the user may receive an access denied message, indicating that their connection has been revoked. Similarly, if the user tries to log in to an internal system through a VPN or remote desktop session, the blocking module 214 may terminate the session and prevent reauthentication, ensuring that the user is completely disconnected from internal resources.

The blocked network activities between the working devices 106-116 and the additional device(s) may include, but are not limited to, sending an automated email to administrators regarding the detected data exfiltration attempt, disabling access to newly created or unauthorized network shared drives, blocking outbound emails containing sensitive information, disabling web-based data transfers (such as file uploads to third-party services), and disabling any USB data transfer activities. Additionally, the blocking module 214 may enable automated text scanning to analyze outgoing data for sensitive keywords or patterns before allowing transmission.

In some embodiments, the blocking module 214 may implement adaptive security measures based on the severity of the data exfiltration attempt. If a minor and/or low risk data exfiltration attempt is detected, the system may issue a warning or require managerial approval before allowing data transfer. However, if a high-risk activity is identified, such as an attempt to transfer classified documents to an unapproved external device, the blocking module 214 may trigger immediate network disconnection, revoke access privileges, or initiate account suspension.

The report generation module 216 may generate a descriptive report 216a that provides a comprehensive summary of a user's past activity, security actions taken, and details of the detected data exfiltration attempt. The report 216a may include, but is not limited to, a summary of the user's past activity (e.g., user report 209a), user's threat score (e.g., threat score 209b), a record of actions taken to block network activities (e.g., blocking module 214), a log of actions taken to disable the working devices 106-116 (e.g., disabling module 212), and the type of data exfiltration attempt detected (e.g., screen capture module 210). The report generation module 216 may utilize a report generation machine learning model to generate a descriptive report 216a. The report generation machine learning model may be a large language model (LLM) that contextualizes the collected data and provides natural language descriptions of the detected security incident. The report generation machine learning model may analyze logs, flagged activities, and security enforcement actions to generate a clear and structured summary, making it easier for security analysts to review the incident.

The descriptive report 216a may aid in capturing and correlating at least some of the actions involved in the data exfiltration attempt within a single document. For example, if a user attempted to exfiltrate data using a secondary recording device, the report may include timestamps, screenshots from the working device's security cameras, logs of network activity blocks, and details of enforcement actions, such as device lockdowns or access revocations. Additionally, the descriptive report 216a may categorize the severity level of the incident based on the user's risk profile, past behavior, and sensitivity of the compromised data.

Depending on the intended audience, such as security administrators, the executive team, compliance officers, or incident response teams, the report generation machine learning model may generate different summaries tailored to their specific needs. For example, for security administrators, the descriptive report 216a may provide an in-depth breakdown of the security actions taken, including timestamps, enforcement measures, and logs of detected anomalies. In contrast, for the executive team, the report may present a high-level summary, focusing on the nature and extent of the impacted information, potential business risks, and recommended next steps. By customizing the level of detail in the report, the report generation module 216 ensures that each stakeholder receives relevant insights while maintaining efficiency in incident response and decision-making.

In some embodiments, the descriptive report 216a may be an internal log of characteristics rather than a physical document. The internal log of characteristics can be used by the security system and machine learning models for further analysis. The descriptive report 216a may serve as a structured dataset that records various security-related events, including detected anomalies, user behaviors, security actions taken, and system responses. Such internal log may be continuously updated and referenced by the insider threat module 218 and other components of the security server 202 to refine threat detection and improve risk assessments.

The insider threat module 218 may collect and analyze various data sources to assess the legitimacy of a detected data exfiltration attempt. These data sources may include the user report 209a, which logs anomalous user activities; the threat score 209b, which quantifies the user's security risk to the organization; data exfiltration attempt indicators, such as screen capture events or detected camera lenses; and the descriptive report 216a, which details the functionalities disabled on the working devices 106-116, as well as blocked network activities. By analyzing these data points collectively, the insider threat module 218 determines whether the detected data exfiltration attempt represents a genuine security threat or a false positive.

The insider threat module 218 may utilize an insider threat machine learning model to evaluate and finalize its decision. For example, while the screen capture module 210 may detect an obstructed camera view on a working device and classify it as a potential data exfiltration attempt, the insider threat machine learning model may analyze additional behavioral context and determine that the obstruction was caused by an innocuous action, such as a user wiping the camera lens to clean it. The insider threat machine learning model may be trained using labeled datasets containing real-world and simulated insider threat scenarios. These datasets may include instances of actual unauthorized data exfiltration attempts, such as users attempting to record screens with external devices, tampering with built-in security measures, or transferring classified files to unauthorized locations. Additionally, the model may be trained on false positive scenarios, such as users adjusting their workspace, accidental screen captures, or routine administrative tasks that resemble security violations but do not pose a real threat.

If the insider threat module 218 determines that the data exfiltration attempt was a false positive, the insider threat module 218 may take corrective actions by transmitting a password or authorization code to a user (e.g., via a user device) that can enable previously disabled functionalities and/or resume blocked network activities. This ensures that legitimate user actions are not unnecessarily restricted due to false alarms. The insider threat module 218, upon receiving the passcode from the user (e.g., by entering the passcode to the working devices 106-116) can enable the one or more functionality and resume blocked network activities. In some embodiments, rather than making an automated decision, a security analyst may review the collected data and determine whether to reinstate access. This approach provides a balance between automated threat detection and human oversight, reducing disruptions while maintaining security integrity. Additionally, the security server 202 may receive a user request to restore disabled functionalities and resume blocked network activities. The insider threat module 218 may evaluate the request based on a request description and determine whether reinstatement is appropriate. For example, if the request provides a clear and legitimate explanation, such as an explanation that the user was conducting an authorized system test or routine documentation, the insider threat module may approve the request, and enable the one or more functionalities of the working devices 106-116 by providing the passcode to the user. Conversely, if the request lacks sufficient justification or contains inconsistent details, the insider threat module may escalate the request for further review by a security administrator before making a final determination.

As shown in FIG. 2, the memories 207 may store various applications for execution by the processor 204. The training module 220 may employ various machine learning techniques such as supervised learning, unsupervised learning, and reinforcement learning to train the one or more machine learning models as described in FIG. 1. The one or more machine learning models may include, but are not limited to, the confidential machine learning model of the sensitive data detection module 208, a user activity machine learning model of the user activity module 209, an object recognition machine learning model of the screen capture module 210, and an report generation machine learning model of the report generation module 216, and insider threat machine learning model of the insider threat module 218

The networking interface 206 may enable the security server 202 to communicate with other devices, and/or any other suitable devices or combinations thereof. The networking interface 206 may support wired or wireless communications, such as USB, Bluetooth, Wi-Fi Direct, Near Field Communication (NFC), etc. The networking interface 206 may enable the security server 202 to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network, or may include multiple communication networks of one or more types (e.g., one or more wired and/or PANs or LANs, and/or one or more WANs such as the Internet).

More generally, the one or more processors 204 may include any suitable number of processors and/or processor types. For example, the processors 204 may include one or more CPUs and one or more graphics processing units (GPUs). Generally, each of the processors 204 may be configured to execute software instructions stored in the corresponding one or more memories 207. The memories 207 may include one or more persistent memories (e.g., a hard drive and/or solid-state memory) and may store one or more applications, modules, and/or models, such as the sensitive data detection module 208, the user activity module 209, and/or the screen capture module 210.

FIG. 3 illustrates an example flow diagram for detecting and/or protecting against a data transfer attempt (e.g., a data exfiltration attempt) of one or more working devices 106-116 by a user 302. In some embodiments, the flow diagram of FIG. 3 may be implemented by the environment of FIG. 1. The security server detects a presence of sensitive data displayed on the one or more working devices 106-116 by applying a sensitive data detection module 308 to screen data. It will be understood that various components described with regard to FIG. 3 may correspond to various components of FIGS. 1 and/or 2. For example, the sensitive data detection module 308 may correspond to the sensitive data detection module 208 of FIG. 2. As such, implementation(s) that apply to the elements of FIGS. 1 and/or 2 may similarly apply to the corresponding elements of FIG. 3 (e.g., implementations that apply to the sensitive data detection module 208 may similarly apply to the sensitive data detection module 308). The sensitive data detection module 308 may employ a confidential machine learning model to identify sensitive content in real time. In some embodiments, the sensitive data detection module 308 utilizes an entity recognition model to detect sensitive information, such as personally identifiable information (PII), financial records, and/or classified business data.

If the security server determines that the displayed content is not sensitive, the security server may permit a data transfer attempt (block 320), as there are no confidentiality concerns. For example, when a user attempts to screen capture a publicly available document or generic system information, the security server may allow the screen capture without restriction. However, when the security server detects that sensitive information is displayed on the screen, the security server may activate the screen capture module 310 to monitor and restrict any unauthorized data transfer attempt.

The screen capture module 310 may detect a data exfiltration attempt associated with the sensitive data by the user 302 via the one or more working devices 106-116. For example, the user 302 may try to capture sensitive information displayed on the working devices 106-116 using a personal device, obstruct the cameras of the working devices to bypass security measures, or initiate a screen capture of the displayed content. The screen capture module 310 may correspond to the screen capture module 210 of FIG. 2, and the implementation(s) that apply to the screen capture module 210 of FIG. 2 may similarly apply to the screen capture module 310. To identify such activities, the screen capture module 310 may utilize an object recognition module (e.g., the object recognition module 210A of FIG. 2), which analyzes a visual stream of visual data received from the cameras of the working devices 106-116. The object recognition module may detect camera lenses of a user device in various conditions, including different angles, lighting environments, and device types. Additionally, the object recognition module may identify attempts to obstruct or disrupt the one or more camera of the working device, such as covering the lens or tampering with the device's camera settings. The object recognition module may detect the camera lens by using an object recognition machine learning model to the visual stream or analyze the visual stream to detect the attempt to disrupt the one or more cameras of the working device. Upon detecting a data exfiltration attempt, the security server may take immediate action using the disabling module 312 to restrict the user's access. The screen capture module 310 may also detect the data exfiltration attempt by detecting a screen capture event of the working device associated with the sensitive data.

The security server may also utilize the user activity module 309 to analyze past user data and identify anomalous user behavior, generating a user report that details any detected irregularities. The user activity module 309 may correspond to the user activity module 209 of FIG. 2, and the implementation that apply to the user activity module 209 of FIG. 2 may similarly apply to the user activity module 309. The past user activity data may comprise user web activity, user endpoint activity, user email activity, user cloud activity, or user sign-in activities. The anomalous user behavior may include unauthorized access attempts, unusual login patterns, excessive file downloads, unauthorized data transfers, or deviations from typical work activity. In addition to detecting anomalous behavior, the user activity module 309 may determine a threat score for the user. The threat score represents the level of security risk posed by the user based on factors such as past activity patterns, access privileges, and the sensitivity of the data being accessed. A higher threat score may indicate behaviors associated with potential insider threats or security violations, while a lower score may correspond to routine user activity. The user activity module 309 may utilize a user activity machine learning model trained on historical security incidents, behavioral patterns, and risk assessment metrics to generate the user report and/or the threat score

The security server may then use the disabling module 312 to disable one or more functionalities associated with the working device to prevent unauthorized data exfiltration. The disabling module 312 may correspond to the disabling module 212 of FIG. 2, and the implementation that apply to the disabling module 212 of FIG. 2 may similarly apply to the disabling module 312. The disabled functionalities may include, but not limited to, locking the user screen, disabling input peripherals such as the keyboard and mouse, freezing the user screen, darkening the user screen, or delete existing content to restrict the user's ability to continue the data exfiltration attempt. Additionally, the disabling module 312 may delete or encrypt existing content stored on the working device to prevent unauthorized access.

Upon disabling the one or more functionalities, the security server may use the blocking module 314 to block network traffic activities between the working device and another device, such as internal server computers, external cloud storage services, or email recipients. The blocking module 314 may correspond to the blocking module 214 of FIG. 2, and the implementation that apply to the blocking module 214 of FIG. 2 may similarly apply to the blocking module 314. The blocked network traffic activities may include sending an automated email to administrators, disabling newly added network shared drives, blocking outbound emails, disabling web based data transfers, disabling any USB data transfer activities, and/or enabling automated text scanning.

The security server may then use the report generation module 316 to generate a descriptive report that provides a comprehensive summary of the security event. The report generation module 316 may correspond to the report generation module 216 of FIG. 2, and the implementation that apply to the report generation module 216 of FIG. 2 may similarly apply to the report generation module 316. This report is based on multiple data sources, including the user report (e.g., from the user activity module 309), which details anomalous activities; the threat score (e.g., from the user activity module 309), which quantifies the user's security risk; a record of actions taken to block network activities (e.g., from the blocking module 314); a log of actions taken to disable one or more working devices 106-116 (e.g., from the disabling module 312); and the type of data exfiltration attempt detected (e.g., from the screen capture module 310). To generate this report, the security server may utilize a report generation machine learning model, which may be a large language model (LLM) trained to process security event data and produce structured, human-readable summaries.

The security server may collect and analyze multiple data sources to assess the legitimacy of a detected data exfiltration attempt. As illustrated in FIG. 3, the insider threat module 318 may aggregate data from various security components, including the user report, which logs anomalous user activities; the threat score, which quantifies the user's security risk to the organization; data exfiltration attempt indicators, such as screen capture events or detected camera lenses; and the descriptive report, which details the functionalities disabled on the working devices 106-116 and blocked network activities. The insider threat module 318 may correspond to the insider threat module 218 of FIG. 2, and the implementation that apply to the insider threat module 218 of FIG. 2 may similarly apply to the insider threat module 318. By evaluating these data sources collectively, the insider threat module 318 determines whether the detected data exfiltration attempt constitutes a genuine security threat or a false positive. To enhance accuracy, the insider threat module 318 may utilize an insider threat machine learning model trained to analyze behavioral patterns, contextual data, and historical threat incidents. The insider threat model may enable the system to distinguish between legitimate user activities and potential security violations, minimizing false alarms while ensuring effective threat detection and response.

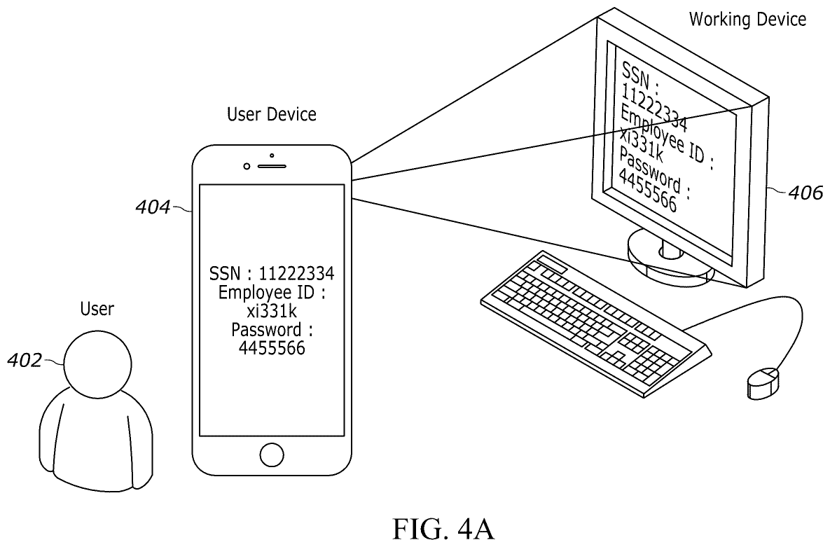

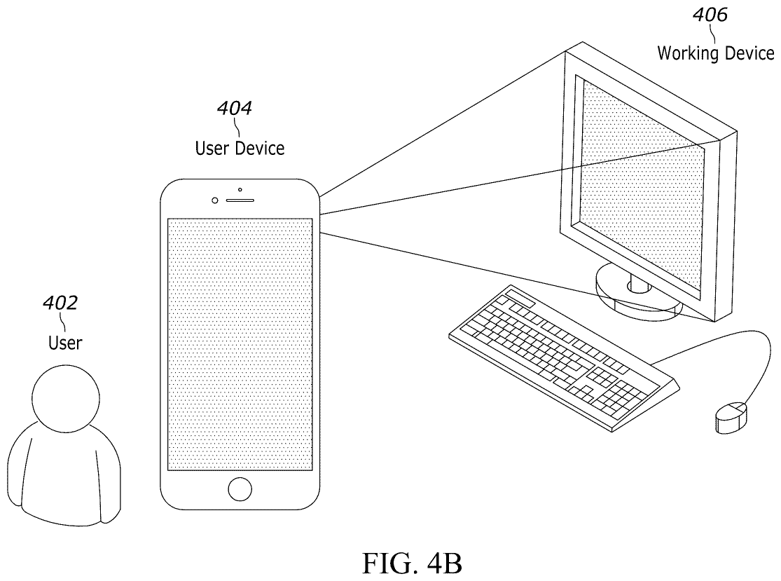

FIGS. 4A and 4B illustrate an example of how a working device is protected from an unauthorized data transfer attempt (e.g., a data exfiltration attempt) by a user. In FIG. 4A, a user 402 is using a user device 404 to attempt a data transfer from a working device 406. The working device 406 may display sensitive information, such as a social security number (SSN), employee ID number, and an account password. The user 402 attempts to capture the displayed screen using the one or more cameras of the user device 404 to extract this sensitive data.

In FIG. 4B, upon detecting the presence of one or more cameras, the working device 406 may initiate a security response to prevent unauthorized data transfer. Specifically, the working device 406 may darken its screen, making the displayed information unreadable to the user device 404. By disabling visibility on the working device 406, the system effectively prevents the user 402 from capturing sensitive data. This response ensures that even if an unauthorized recording attempt occurs, no valuable information can be extracted, thereby successfully protecting against data exfiltration.

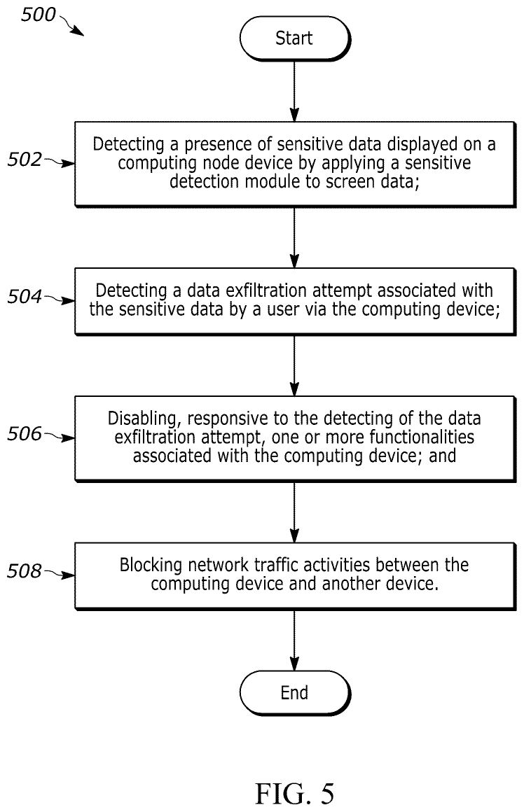

FIG. 5 is a flow diagram of an example method for detecting and/or protecting against a data transfer attempt (e.g., a data exfiltration attempt) of a computing device by a user, according to some embodiments. The method 500 may be implemented by one or more processors of the one or more servers of the example security system 100. The method 500 may include additional, fewer, or alternative steps depending on specific implementation requirements, system configurations, or security policies.

The method 500 may begin with detecting a presence of sensitive data displayed on a computing node device by applying a sensitive data detection module to the screen data (block 502). The sensitive data detection module may use a machine learning-based confidential model to identify personally identifiable information (PII), financial records, classified business documents, or other proprietary data displayed on the screen. In some embodiments, the sensitive data detection module may utilize an entity recognition model configured with pre-defined rules to scan screen data for sensitive data, such as social security numbers, credit card information, or classification markers.

The method 500 then includes detecting a data transfer attempt associated with the sensitive data by a user via the computing device (block 504). The detecting of the data transfer attempts may include detecting at least one of a user device or an attempt to disrupt one or more cameras of the computing device. The security system may receive, from one or more cameras, a visual stream of visual data. The security system may then perform at least one of: (i) detecting the camera lens by using an object recognition module to the visual stream or (ii) analyzing the visual stream to detect an attempt to disrupt the one or more cameras. Specifically, the security system may detect such an attempt through at least one of multiple mechanisms, including monitoring active processes, keystroke patterns, and system logs for indicators of data transfer activities. These activities may include capturing screenshots, recording the screen, initiating screen-sharing sessions, copying content to the clipboard, printing documents, or transferring files via external storage devices or cloud services. Additionally, physical attempts to exfiltrate data (e.g., using a secondary recording device like a smartphone, tablet, or external camera) may also be detected.

Upon detecting an unauthorized data transfer attempt, the method 500 may disable, responsive to the detecting of the data transfer attempt, one or more functionalities associated with the computing device (block 506). These functionalities may include any of locking the user screen, freezing the user interface, disabling input peripherals such as the keyboard and mouse, darkening the screen, deleting existing content of the computing device, and/or restricting access to sensitive applications to prevent further user actions. Additionally, the security system may delete and/or encrypt data on the computing device to ensure that unauthorized users cannot retrieve or manipulate the sensitive information.

If the detected data transfer attempt involves physical obstruction of the built-in security cameras (e.g., covering the lens, applying screen overlays, or disabling the camera feed) the security system may enforce additional security actions. These may include activating secondary monitoring tools, enabling additional authentication requirements, or escalating the incident to a security administrator for manual review.

The method 500 further includes blocking network traffic activities between the computing device and another node (block 508). The security system may restrict data transmissions to one or both of external and internal destinations, ensuring that sensitive information cannot be exfiltrated through unauthorized channels. The blocked network activities may include preventing outbound emails containing sensitive attachments, disabling access to newly added network shared drives, blocking unauthorized file uploads to cloud storage services, terminating remote desktop sessions, disabling any USB data transfer activities, enabling automated text scanning, sending an automated email to administrators, and/or restricting VPN or proxy-based access attempts.

In some embodiments, the security system may use real-time traffic analysis and deep packet inspection to monitor ongoing data transmissions. If an unauthorized data transfer attempt is detected mid-transfer, the computer system may immediately terminate the session, revoke the user's network privileges, and/or quarantine the affected computing device to prevent further data leakage.

The method 500 may further include determining a threat score for the user or anomalies in past user activity data that indicate possible data transfer attempts by using a user activity module. The user activity module may analyze historical user behavior, access patterns, and risk indicators to dynamically assess the level of security risk associated with the detected data transfer attempt. The user activity module may track various factors, including web activity, endpoint interactions, email exchanges, cloud storage usage, and/or login attempts, to determine whether the current behavior aligns with known threat patterns. Based on the analysis, the user activity module may assign a threat score, which may influence the severity of security actions taken. For example, a user with a history of suspicious activity may trigger an immediate device lockdown and security review, whereas a first-time offender may receive a warning or require additional authentication before continuing operations.

The method 500 may also include generating an activity report of the user using a report generation module on past user activity data and/or the blocked network traffic activities. The report generation module may compile a detailed summary of the user's actions, security responses, and system interventions into an internal log or structured document. The report may be automatically fed into machine learning models to enhance future threat detection or reviewed manually by security analysts for forensic investigation.

The method 500 may also include restoring disabled functionalities under certain conditions. If the insider threat module determines that the detected data transfer attempt was a false positive, the system may allow the user to request a passcode or authorization key to restore blocked functionalities and resume network access. The restoration process may involve user identity verification, administrative approval, or predefined security policies to ensure that access is reinstated only under legitimate circumstances.

By integrating multi-layered threat detection, real-time security enforcement, behavioral analysis, and adaptive risk assessment, the method 500 provides a comprehensive approach to detecting and mitigating unauthorized data transfer attempts while minimizing disruptions to legitimate user activities.

### EXAMPLE LANGUAGE MODEL ARCHITECTURE

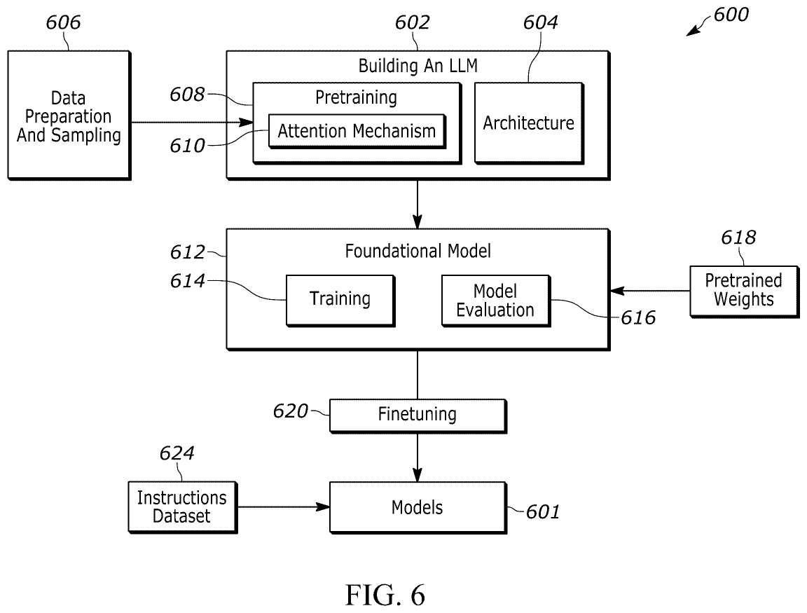

FIG. 6 depicts a block flow diagram of an example computer-implemented method 600 for training and/or operating a machine learning model (ML model), according to embodiments. The ML may include one or more tiny, small, large, hybrid, or specialized models, depending on the intended application. The method 600 provides a high-level overview of steps involved in setting up, training, and utilizing a machine learning model. The method 600 provides a high-level overview of steps involved in setting up, training, and utilizing a machine learning model. The method 600 may include several components and processes, starting with data preparation and sampling (block 606), which involves collecting, cleaning, and structuring training data. This step may include data normalization, augmentation, labeling, and filtering to ensure high-quality and diverse training datasets. The prepared data is then passed into the pretraining section (block 608). The pretraining section may include an attention mechanism and specialized architectures designed to enhance the model's ability to capture complex dependencies and relationships within the data (e.g., by selectively attending to different parts of the input data and/or assigning varying degrees of importance or weight to different elements). The pretraining section may learn foundational patterns from large datasets to develop a broad understanding of relevant features before being further refined in subsequent training stages. During pretraining, the ML model may incorporate various architectural components depending on its design. These may include convolutional layers for image-based tasks, attention mechanisms for sequential data, recurrent layers for time-series analysis, or dense layers for general-purpose learning.

From the pretraining, the flow moves to a foundational model (block 612) which branches into two main components: model training (block 614) and model evaluation (block 616), which involves iterative refinements based on performance metrics. The model training (block 614) step may involve feeding the foundational model with labeled datasets specific to the target domain, enabling it to learn task-specific patterns and relationships. This phase may include supervised learning, where the model learns from labeled examples, or unsupervised learning, where the model clusters or structures raw data without explicit labels. In some embodiments, the model training may involve reinforcement learning. The model evaluation (block 616) step may assess the model using techniques such as cross-validation, loss function analysis, accuracy measurements, or precision-recall trade-offs. In some embodiments, pretrained weights 618 may be incorporated to tune the weights of the foundational model (block 612). The model may undergo a feedback loop based on the output to refine the weights of the foundational model.

Once the foundational model has been established, the process may continue with finetuning (block 620), wherein further refinement of the model's parameters is performed to enhance its performance or adapt it to specific tasks. Finally, this refined model flows into a machine learning model (block 601), influenced by an instructions dataset (block 624), which indicates that the model's operation can be directed or influenced by specific instructions. The machine learning model (block 601) may include, but not limited to, a machine learning model for detecting camera lenses, smart phones, and/or other indications of an imaging device (e.g., object recognition module 26a of FIG. 2), a machine learning model that determines whether a user's screen is displaying sensitive data (e.g., sensitive data detection module 208 of FIG. 2), and/or a risk assessment model (e.g., machine learning model) for generating a user threat score

Training data for training in the method 600 may encompass a wide range of information relevant to protecting against a data transfer attempt (e.g., a data exfiltration attempt) by a user. This data serves as the foundation for the model to learn patterns, relationships, and insights that are critical for making informed decisions such as detecting a data transfer attempt, detecting a presence of sensitive data, and/or blocking network traffic activities. The training data may include visual streams such as images and videos for the machine learning model for detecting camera lenses, screen image datasets for the machine learning model that determines whether a user's screen is displaying sensitive data, historical user activity data for the risk assessment model, and many others. The training process may involve preprocessing this data to ensure it is in a format suitable for analysis, followed by the application of machine learning techniques, including neural networks, deep learning algorithms, and reinforcement learning with human feedback.

An example implementation of method 600 may involve training and deploying a machine learning model for detecting camera lenses to enhance security by preventing unauthorized recording attempts. The data preparation and sampling (block 606) phase may involve collecting thousands of images and videos of various camera lenses from smartphones, tablets, laptops, and external webcams, ensuring diversity in lighting conditions, angles, obstructions, and environmental settings. The pretraining section (block 608) may use a convolutional neural network (CNN) architecture combined with an attention mechanism, allowing the model to focus on key image features related to camera lens detection.

The foundational model (block 612), comprising model training (block 614) and model evaluation (block 616), may then be trained on large-scale vision datasets containing labeled camera lens images, enabling the model to recognize key characteristics of imaging devices. Model training (block 614) may involve iterative refinement through supervised learning, transfer learning, and adversarial training, where the model learns to differentiate between actual camera lenses and false positives, such as reflective surfaces or round objects. The model evaluation (block 616) stage may validate performance using cross-validation, loss function analysis, and accuracy benchmarks, ensuring the model generalizes well to real-world scenarios. A feedback loop back to pretrained weights (block 618) may allow misclassified objects to be corrected over successive training iterations, improving detection robustness.

The fine-tuning stage (block 620) may further optimize the model for real-world deployment, enhancing its adaptability to different environments by incorporating data augmentation techniques, domain-specific optimizations, and real-time inference improvements. The security server may then utilize the final, fine-tuned model (machine learning model 601).

### EXAMPLES

The following list of examples reflects a variety of the embodiments explicitly contemplated by the present disclosure. Those of ordinary skill in the art will readily appreciate that the examples below are neither limiting of the embodiments disclosed herein, nor exhaustive of all of the embodiments conceivable from the disclosure above, but are instead meant to be exemplary in nature.
Aspect 1. A method of protecting a data exfiltration attempt of a computing device by a user, the method comprising: detecting, by one or more processors, a presence of sensitive data displayed on a computing device by applying a sensitive data detection module to screen data; detecting, by the one or more processors, a data exfiltration attempt associated with the sensitive data by a user via the computing device; disabling, by the one or more processors and responsive to the detecting of the data exfiltration attempt, one or more functionalities associated with the computing device; and blocking, by the one or more processors, network traffic activities between the computing device and another device.
Aspect 2. The method of aspect 1, wherein the detecting of the data exfiltration attempt further comprises: detecting, by the one or more processors, at least one of a camera lens of a user device or an attempt to disrupt one or more cameras of the computing device.
Aspect 3. The method of either one of aspects 1 or 2, wherein the detecting of the at least one of the camera lens or the attempt to disrupt further comprises: receiving, by the one or more processors from the one or more cameras of the computing device, a visual stream of visual data; and performing at least one of: detecting, by the one or more processors, the camera lens by using an object recognition module to the visual stream; or analyzing, by the one or more processors, the visual stream to detect the attempt to disrupt the one or more cameras.
Aspect 4. The method of aspect 1, wherein the detecting of the data exfiltration attempt further comprises: detecting, by the one or more processors, a screen capture event of the computing device.
Aspect 5. The method of aspect 1, further comprising: determining, by the one or more processors, at least one of a threat score of the user or anomalies in past user activity data that indicate possible data exfiltration attempts by using a user activity module.
Aspect 6. The method of any one of aspects 1-5, wherein the past user activity data comprises at least one of: user web activity, user endpoint activity, user email activity, user cloud activity, or user sign-in activities.
Aspect 7. The method of aspect 1, wherein the blocking of the network traffic activities between the computing device and the another device further comprises at least one of: sending, by the one or more processors, an automated email to administrators; disabling, by the one or more processors newly added network shared drives, blocking, by the one or more processors, outbound emails, disabling, by the one or more processors, web based data transfers, disabling, by the one or more processors, any USB data transfer activities, or enabling, by the one or more processors, automated text scanning.
Aspect 8. The method of aspect 1, further comprising: generating, by the one or more processors, an activity report of the user by using a report generation module on past user activity data or the blocked network traffic activities.
Aspect 9. The method of aspect 1, wherein the disabling of the one or more functionalities associated with the computing device further comprises at least one of: locking, by the one or more processors, a user screen of the computing device requiring a passcode, deleting, by the one or more processors, existing content of the computing device, freezing, by the one or more processors, the user screen of the computing device, darkening, by the one or more processors, the user screen of the computing device, or disabling, by the one or more processors, a keyboard and a mouse of the computing device.
Aspect 10. The method of aspect 1, further comprising: transmitting, by the one or more processors, a passcode to a user device of the user that, when input into the user device, enables the one or more functionalities; receiving, by the one or more processors from the computing device, the passcode; and enabling, by the one or more processors, the one or more functionalities.
Aspect 11. A computer system for protecting a data exfiltration attempt of a computing device by a user, comprising: one or more processors, and a tangible, non-transitory memory coupled to the one or more processors and storing executable instructions that, when executed by the one or more processors, causes the computer system to: detect a presence of sensitive data displayed on a computing device by applying a sensitive data detection module to screen data; detect a data exfiltration attempt associated with the sensitive data by a user via the computing device; disable, responsive to the detecting of the data exfiltration attempt, one or more functionalities associated with the computing device; and block network traffic activities between the computing device and another device.
Aspect 12. The computer system of aspect 11, wherein the instructions to detect the data exfiltration attempt comprise further instructions that, when executed by the one or more processors, further causes the computer system to: detect at least one of a camera lens of a user device or an attempt to disrupt one or more cameras of the computing device.
Aspect 13. The computer system of either one of aspects 11 or 12, wherein the instructions to detect at least one of the camera lens or the attempt to disrupt comprise further instructions that, when executed by the one or more processors, further causes the computer system to: receive, from the one or more cameras of the computing device, a visual stream of visual data; and perform at least one of: detect the camera lens by using an object recognition module to the visual stream; or analyze the visual stream to detect an attempt to disrupt the one or more cameras.
Aspect 14. The computer system of aspect 11, wherein the instructions to detect the data exfiltration attempt comprise further instructions that, when executed by the one or more processors, further causes the computer system to: detect a screen capture event of the computing device.
Aspect 15. The computer system of aspect 11, wherein the instructions, when executed by the one or more processors, further causes the computer system to: determine at least one of a threat score of the user or anomalies in past user data that indicate possible data exfiltration attempt by using a user activity module.
Aspect 16. The computer system of any one of aspects 11 to 15, wherein the past user activity data comprises at least one of: user web activity, user endpoint activity, user email activity, user cloud activity, or user sign-in activities.
Aspect 17. The computer system of aspect 11, wherein the instructions to block network traffic activities between the computing device and another device comprise further instructions that, when executed by the one or more processors, further causes the computer system to perform at least one of: send an automated email to administrators; disable newly added network shared drives, block outbound emails, disable web based data transfers, disable any USB data transfer activities, or enable automated text scanning.
Aspect 18. A non-transitory computer-readable medium storing executable instructions for protecting a data exfiltration attempt of a computing device by a user that, when executed by one or more processors, causes a computing system to: detect a presence of sensitive data displayed on a computing device by applying a sensitive data detection module to screen data; detect a data exfiltration attempt associated with the sensitive data by a user via the computing device; disable, responsive to the detecting of the data exfiltration attempt, one or more functionalities associated with the computing device; and block network traffic activities between the computing device and another device.
Aspect 19. The non-transitory computer-readable medium of aspect 18, wherein the instructions further cause the computing system to: generate an activity report of the user by using a report generation module on past user activity data or the blocked network traffic activities.
Aspect 20. The non-transitory computer-readable medium of aspect 18, wherein the instructions to disable the one or more functionalities associated with the computing device further cause the computing system to: lock a user screen of the computing device requiring a passcode, delete existing content of the computing device, freeze the user screen of the computing device, darken the user screen of the computing device, or disable a keyboard and a mouse of the computing device.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for evaluating reliability of a response generated by a language model through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of protecting a data exfiltration attempt of a computing device by a user, the method comprising:
detecting, by one or more processors, a presence of sensitive data displayed on a computing device by applying a sensitive data detection module to screen data;
detecting, by the one or more processors, a data exfiltration attempt associated with the sensitive data by a user via the computing device;
disabling, by the one or more processors and responsive to the detecting of the data exfiltration attempt, one or more functionalities associated with the computing device; and
blocking, by the one or more processors, network traffic activities between the computing device and another device.

2. The method of claim 1, wherein the detecting of the data exfiltration attempt further comprises:
detecting, by the one or more processors, at least one of a camera lens of a user device or an attempt to disrupt one or more cameras of the computing device.

3. The method of claim 2, wherein the detecting of the at least one of the camera lens or the attempt to disrupt further comprises:
receiving, by the one or more processors from the one or more cameras of the computing device, a visual stream of visual data; and
performing at least one of:
detecting, by the one or more processors, the camera lens by using an object recognition module to the visual stream; or
analyzing, by the one or more processors, the visual stream to detect the attempt to disrupt the one or more cameras.

4. The method of claim 1, wherein the detecting of the data exfiltration attempt further comprises:
detecting, by the one or more processors, a screen capture event of the computing device.

5. The method of claim 1, further comprising:
determining, by the one or more processors, at least one of a threat score of the user or anomalies in past user activity data that indicate possible data exfiltration attempts by using a user activity module.

6. The method of claim 5, wherein the past user activity data comprises at least one of:
user web activity, user endpoint activity, user email activity, user cloud activity, or user sign-in activities.

7. The method of claim 1, wherein the blocking of the network traffic activities between the computing device and the another device further comprises at least one of:
sending, by the one or more processors, an automated email to administrators;
disabling, by the one or more processors newly added network shared drives,
blocking, by the one or more processors, outbound emails,
disabling, by the one or more processors, web based data transfers,
disabling, by the one or more processors, any USB data transfer activities, or
enabling, by the one or more processors, automated text scanning.

8. The method of claim 1, further comprising:
generating, by the one or more processors, an activity report of the user by using a report generation module on past user activity data or the blocked network traffic activities.

9. The method of claim 1, wherein the disabling of the one or more functionalities associated with the computing device further comprises at least one of:
locking, by the one or more processors, a user screen of the computing device requiring a passcode,
deleting, by the one or more processors, existing content of the computing device,
freezing, by the one or more processors, the user screen of the computing device,
darkening, by the one or more processors, the user screen of the computing device, or
disabling, by the one or more processors, a keyboard and a mouse of the computing device.

10. The method of claim 1, further comprising:
transmitting, by the one or more processors, a passcode to a user device of the user that, when input into the user device, enables the one or more functionalities;
receiving, by the one or more processors from the computing device, the passcode; and
enabling, by the one or more processors, the one or more functionalities.

11. A computer system for protecting a data exfiltration attempt of a computing device by a user, comprising:
one or more processors, and
a tangible, non-transitory memory coupled to the one or more processors and storing executable instructions that, when executed by the one or more processors, causes the computer system to:
detect a presence of sensitive data displayed on a computing device by applying a sensitive data detection module to screen data;
detect a data exfiltration attempt associated with the sensitive data by a user via the computing device;
disable, responsive to the detecting of the data exfiltration attempt, one or more functionalities associated with the computing device; and
block network traffic activities between the computing device and another device.

12. The computer system of claim 11, wherein the instructions to detect the data exfiltration attempt comprise further instructions that, when executed by the one or more processors, further causes the computer system to:
detect at least one of a camera lens of a user device or an attempt to disrupt one or more cameras of the computing device.

13. The computer system of claim 12, wherein the instructions to detect at least one of the camera lens or the attempt to disrupt comprise further instructions that, when executed by the one or more processors, further causes the computer system to:
receive, from the one or more cameras of the computing device, a visual stream of visual data; and
perform at least one of:
detect the camera lens by using an object recognition module to the visual stream; or
analyze the visual stream to detect an attempt to disrupt the one or more cameras.

14. The computer system of claim 11, wherein the instructions to detect the data exfiltration attempt comprise further instructions that, when executed by the one or more processors, further causes the computer system to:
detect a screen capture event of the computing device.

15. The computer system of claim 11, wherein the instructions, when executed by the one or more processors, further causes the computer system to:
determine at least one of a threat score of the user or anomalies in past user data that indicate possible data exfiltration attempt by using a user activity module.

16. The computer system of claim 15, wherein the past user activity data comprises at least one of:
user web activity, user endpoint activity, user email activity, user cloud activity, or user sign-in activities.

17. The computer system of claim 11, wherein the instructions to block network traffic activities between the computing device and another device comprise further instructions that, when executed by the one or more processors, further causes the computer system to perform at least one of:
send an automated email to administrators;
disable newly added network shared drives,
block outbound emails,
disable web based data transfers,
disable any USB data transfer activities, or
enable automated text scanning.

18. A non-transitory computer-readable medium storing executable instructions for protecting a data exfiltration attempt of a computing device by a user that, when executed by one or more processors, causes a computing system to:
detect a presence of sensitive data displayed on a computing device by applying a sensitive data detection module to screen data;
detect a data exfiltration attempt associated with the sensitive data by a user via the computing device;
disable, responsive to the detecting of the data exfiltration attempt, one or more functionalities associated with the computing device; and
block network traffic activities between the computing device and another device.

19. The non-transitory computer-readable medium of claim 18, wherein the instructions further cause the computing system to:
generate an activity report of the user by using a report generation module on past user activity data or the blocked network traffic activities.

20. The non-transitory computer-readable medium of claim 18, wherein the instructions to disable the one or more functionalities associated with the computing device further cause the computing system to:
lock a user screen of the computing device requiring a passcode,
delete existing content of the computing device,
freeze the user screen of the computing device,
darken the user screen of the computing device, or
disable a keyboard and a mouse of the computing device.
